(19) United States
(12) Patent Application Publication
(10) Pub. No.: US 2012/0135320 A1
(43) Pub. Date: May 31, 2012

(54) MANUFACTURING METHOD OF CATHODE ELECTRODE FOR FUEL CELLS AND CATHODE ELECTRODE FOR FUEL CELLS

(75) Inventors: Junichi KONDO, Hyogo (JP); Tetsuaki HIRAYAMA, Osaka (JP); Akira TAOMOTO, Kyoto (JP); Hisaaki GYOTEN, Osaka (JP)

(73) Assignee: Panasonic Corporation, Osaka (JP)

(21) Appl. No.: 13/306,134

(22) Filed: Nov. 29, 2011

Related U.S. Application Data
(63) Continuation of application No. PCT/JP2011/001180, filed on Mar. 1, 2011.

(30) Foreign Application Priority Data
Mar. 5, 2010 (JP) 2010-049706

(51) Int. Cl. H01M 4/88; H01M 4/92

(52) U.S. Cl. 429/409; 429/524

(57) ABSTRACT

A manufacturing method for a cathode electrode including: (1) mixing a polymerizable electrolyte precursor having an alkylsulfonic acid group and a group represented by (R¹O)₃Si—, with a first solvent to prepare a platinum elution-preventing material; (2) preparing a first liquid by mixing catalyst powders having catalyst particles, the platinum elution-preventing material and a second solvent; (3) polymerizing the platinum elution-preventing material in the first liquid by carrying out a drying treatment under reduced pressure or a heat drying treatment to form a platinum elution-preventing layer containing the polymer of the platinum elution-preventing material on the catalyst powder surfaces to obtain a preventing layer-covered catalyst; (4) mixing the preventing layer-covered catalyst, a third solvent, and an electrolyte to prepare a second liquid; and (5) applying the second liquid on a substrate, and removing the third solvent to obtain the cathode electrode.

### TECHNICAL FIELD

The present invention relates to a manufacturing method of a cathode electrode for fuel cells, and particularly relates to a manufacturing method of a cathode electrode for polymer electrolyte fuel cells.

### BACKGROUND ART

Fuel cells generate electric power by allowing a fuel capable of producing a proton such as hydrogen to electrochemically react with an oxidizing agent containing oxygen such as air.

On catalyst particle surfaces in cathode electrodes of fuel cells, a catalytic reaction occurs with gaseous oxygen, protons present in liquid, and electrons derived from electrically conductive fine powders in the form of a solid to generate water.

The reaction center where the catalytic reaction occurs is generally referred to as a three-phase interface. The area of this three-phase interface is proportional to an effective area (also referred to as ECA, Electrochemical Surface Area) of the catalyst particles that are in contact with an electrolyte layer that can efficiently supply protons. If the decrease of the ECA can be prevented, high cell output characteristics can be obtained for a long period of time.

However, platinum catalysts are eluted when exposed to protonic acid supplied from the electrolyte. Under strong acidic conditions in general fuel cell electrodes, the decrease of the ECA is likely to occur by the acceleration of the elution, in particular. For the electrode reaction, efficient supply of oxygen to the catalyst surface is also indispensable; therefore, in light of both the ECA and oxygen diffusibility, a variety of materials have been developed in order to attain stable and high cell characteristics for a long period of time.

In general, catalyst layers of electrode for fuel cells are formed by mixing, with a polymer electrolyte, catalyst powders in which platinum particles are supported in porous carbon fine powders such as Ketjen black or acetylene black. Further, in order to secure both the ECA and oxygen diffusibility, a method how a polymer electrolyte is mixed with catalyst particles has been investigated. For example, proposed was a method of overcoating a polymer electrolyte on catalyst powders while adjusting the dispersibility of the polymer electrolyte in a solvent stepwise to alter the state of coating of the electrolyte on the catalyst (PTLs 1 and 2).

However, since the method disclosed in PTL 1 or PTL 2 uses a perfluoro-alkylsulfonic acid polymer electrolyte, platinum particles of the catalyst are eluted as the potential alters, leading to deterioration of the catalyst. As a result, a problem of failure in securing stability of the cell has been raised.

For the purpose of increasing the ECA, a method how a hydrocarbon based sulfonic acid polymer electrolyte is chemically bound to a polymerizable functional group as a base point, which had been attached to the surface of catalyst powders, has been also known (PTL 3). However, the electrode produced by this method does not have secured oxygen diffusibility, and a problem of insufficient cell characteristics for use as actual equipment has been involved.

Moreover, various types of additives were proposed in order to secure stability of platinum nanoparticles that serve as a catalyst (PTL 4). However, there arises a problem of decrease in electric conductivity of the electrode since a material that decreases catalyst activity in anyway covers the electrode. Thus, the method of adding an additive to a catalyst cannot achieve satisfactory initial characteristics of cells.

Accordingly, in development of electrodes for fuel cells, it is important to pave the way for obtaining a material that can secure both electric power generation characteristics and stability for a long period of time.

### CITATION LIST

### Patent Literature

[PTL 1]

Japanese Patent Laid-open Publication No. H11-126615

[PTL 2]

Japanese Patent Laid-open Publication No. H07-254419

[PTL 3]

### Japanese Patent Laid-open Publication No. 2007-165005

[PTL 4]

### Japanese Patent Laid-open Publication No. 2007-5292

[PTL 5]

### PCT International Publication No. 2003/026051

### SUMMARY OF INVENTION

### Technical Problem

In constructions of conventional electrodes, it is necessary to use a perfluorocarbon sulfonic acid polymer as a polymer electrolyte in a catalyst layer in order to attain a high output characteristic that satisfies specification requirements of fuel cells. The sulfonic acid group contained in the electrolyte has a significantly great acid dissociation constant due to having a fluorine atom as seen in the chemical structural formula represented by CF₂SO₃H. The platinum nanoparticles dispersed in the electrode are readily eluted with an acid owing to alteration of potential along with such a strong acidic material, and thus the platinum nanoparticles are released and diffused in the electrode material as a platinum complex ion. Then, the platinum complex ions are reduced on other platinum nanoparticles and on the electrolyte material to lead to deposition of platinum. Consequently, the platinum particles are enlarged in the electrode structure, and detached from the electric conductive substrate. Accordingly, it is difficult to secure stability of electric power generation characteristics, since the catalyst gradually deteriorates during the operation of the electric power generation of the fuel cell.

An object of the present invention is to provide a cathode electrode for fuel cells having a structure in which catalyst particles are covered by a sulfonic acid electrolyte having low acidity, and in which a sulfonic acid electrolyte having high acidity is arranged on the external side thereof, whereby deterioration of the catalyst accompanying with the elution of noble metal nanoparticles is prevented, and thus a high output characteristic can be stably maintained. Further provided by the present invention is a manufacturing method of the cathode electrode for fuel cells and a fuel cell having the cathode electrode for fuel cells.

### Solution to Problem

In one aspect, the present invention provides

a manufacturing method of a cathode electrode for fuel cells,

the method comprising steps of:

mixing a compound having a sulfonic acid group and a group represented by (R¹O)₃Si— (wherein, R¹ represents a hydrogen atom or an alkyl group having 1 to 4 carbon atoms) in a single molecule thereof, with a first solvent to prepare a platinum elution-preventing material;

preparing a first liquid by mixing catalyst powders having catalyst particles on at least the surface thereof, the platinum elution-preventing material, and a second solvent;

polymerizing the platinum elution-preventing material in the first liquid by carrying out a drying treatment under reduced pressure or a heat drying treatment to form a platinum elution-preventing layer containing the polymer of the platinum elution-preventing material on the surfaces of the catalyst powder to obtain a preventing layer-covered catalyst;

mixing the preventing layer-covered catalyst, a third solvent and a polymer electrolyte to prepare a second liquid; and

applying the second liquid on a substrate, and removing the third solvent to obtain the cathode electrode.

According to the above constitution, a sufficient amount of a platinum elution-preventing layer can be formed thoroughly even over the vicinity of catalyst particles arranged inside micro structures in an electric conductive carrier such as porous carbon particles, and concurrently an electrolyte layer for highly efficiently supplying protons to the catalyst of the entirety of the cathode electrode can be provided on the external side of the platinum elution-preventing layer.

A polymerizable electrolyte precursor is preferably a compound represented by (R¹O)₃Si—R²—SO₃H (wherein, R¹ represents a hydrogen atom or an alkyl group having 1 to 4 carbon atoms, and R² represents an alkylene group having 1 to 15 carbon atoms).

The first solvent is preferably at least one selected from the group consisting of acetone, an alcohol having 1 to 4 carbon atoms, dimethylacetamide, ethyl acetate, butyl acetate, and tetrahydrofuran.

The polymer electrolyte is preferably a perfluorocarbon sulfonic acid resin.

It is preferred that the platinum elution-preventing material further contains polymerizable spacer precursor not having a protonic acidic functional group but having a polycondensational functional group, and

the polymerization product of the platinum elution-preventing material contains a copolymer of the polymerizable electrolyte precursor and the polymerizable spacer precursor.

The polymerizable spacer precursor is preferably a compound represented by (R³O)ₘSiR⁴ₙ (wherein, R³ represents a hydrogen atom or an alkyl group having 1 to 4 carbon atoms, and R⁴ represents an alkyl group having 1 to 10 carbon atoms; m represents 2, 3 or 4, and n represents 0, 1 or 2; however, the sum of m and n is 4).

According to another aspect, the present invention also relates to a cathode electrode for fuel cells, the cathode electrode comprising catalyst powders having catalyst particles on at least the surface thereof, a platinum elution-preventing layer on the surface of the catalyst powder, and further a polymer electrolyte on the external side thereof, wherein

the platinum elution-preventing layer comprises a copolymer of a polymerizable electrolyte precursor represented by (R¹O)₃Si—R²—SO₃H (wherein, R¹ represents a hydrogen atom or an alkyl group having 1 to 4 carbon atoms, and R² represents an alkylene group having 1 to 15 carbon atoms), and a polymerizable spacer precursor represented by (R₃O)ₘSiR⁴ₙ (wherein, R³ represents a hydrogen atom or an alkyl group having 1 to 4 carbon atoms, and R⁴ represents an alkyl group having 1 to 10 carbon atoms; m represents 2, 3 or 4, and n represents 0, 1 or 2; however, the sum of m and n is 4).

### Advantageous Effects of Invention

According to the cathode electrode for fuel cells of the present invention and a manufacturing method thereof, fuel cells can be manufactured having electric power generation characteristics at a high level with stability for a long period of time.

### BRIEF DESCRIPTION OF DRAWINGS

FIG. 1 shows a process flow chart illustrating the manufacturing method of a cathode electrode for fuel cells according to Embodiment 1 of the present invention.

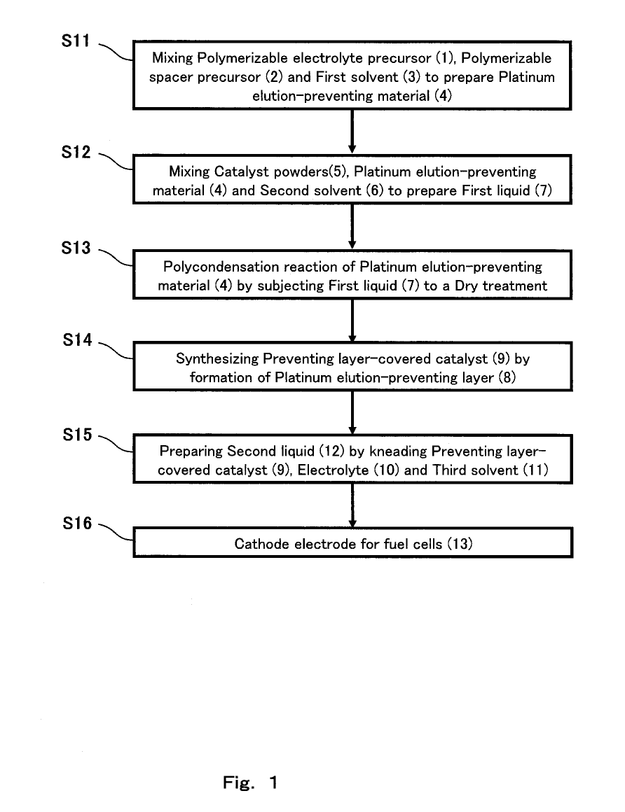

FIG. 2 shows a schematic view illustrating a catalyst-supporting carrier having carbon supporting a catalyst, an electrolyte polymer polymerized in-situ, and an electrolyte polymer mixed in a catalyst paste disclosed in PTL 3.

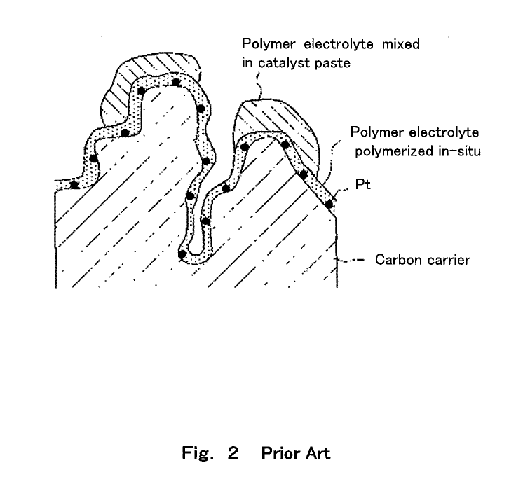

### DESCRIPTION OF EMBODIMENTS

Hereinafter, an embodiment of the present invention will be described with reference to Figures.

In the present embodiment, a cathode electrode for fuel cells is manufactured by carrying out steps S11 to S15. First, in the step S11, a polymerizable electrolyte precursor (1), a polymerizable spacer precursor (2) and a first solvent (3) are mixed to prepare a platinum elution-preventing material (4). The polymerizable spacer precursor (2) may have an optional constitution.

The polymerizable electrolyte precursor (1) is a low molecular weight compound having in a single molecule both a sulfonic acid group, which is a protonic acidic functional group, and a polycondensational functional group. The protonic acidic functional group is a functional group having a function of supplying protons on a platinum catalyst surface where a reduction reaction of oxygen proceeds. Since the platinum elution-preventing material (4) requires a function of supplying protons on the platinum catalyst surface, it contains at least the polymerizable electrolyte precursor (1) as a constitutive element.

The polycondensational functional group is a functional group with which a polycondensation reaction proceeds by heat or vacuum. The polycondensational functional group is particularly preferably a silicon group having a hydroxyl group or an alkoxyl group.

Specifically, preferable silicon groups are silicon groups represented by the formula 1: (R¹O)₃Si— (wherein, R¹ represents a hydrogen atom or an alkyl group having 1 to 4 carbon atoms). Since the platinum elution-preventing material (4) has the polycondensational functional group represented by (R¹O)₃Si—, a polymer can be formed by polymerization in the step S12, which is explained later. During the polymerization, silicon atoms are bound with one another via an oxygen atom to form a siloxane bond, and water or R¹OH is released.

Examples of the alkyl group having 1 to 4 carbon atoms in the formula 1 include a methyl group, an ethyl group, an n-propyl group, an isopropyl group, an n-butyl group, and a t-butyl group. In light of high reactivity and ease in elimination after the polymerization, an ethyl group is preferred as the alkyl group having 1 to 4 carbon atoms in the formula 1.

Specifically as the platinum elution-preventing material (4), a polymerizable electrolyte precursor represented by the formula: (R¹O)₃Si—R²—SO₃H (wherein, R¹ represents a hydrogen atom or an alkyl group having 1 to 4 carbon atoms, and R² represents an alkylene group having 1 to 15 carbon atoms) may be used. R¹ present in the number of 3 in one molecule may be the same or different.

The alkylene group represented by R² may be selected appropriately among alkylene groups having 1 to 15 carbon atoms. This alkylene group may be linear or branched. R² is preferably an alkylene group having 2 to 10 carbon atoms. When R² has 2 to 10 carbon atoms, the amount of the sulfonic acid group (EW value) in the obtained platinum elution-preventing material (4) can be controlled.

The first solvent (3) is used for dissolving the platinum elution-preventing material (4) and/or the polymerizable spacer precursor (2). The first solvent is preferably a polar solvent such that the platinum elution-preventing material (4) and/or the polymerizable spacer precursor (2) can be dissolved. Specific examples of the first solvent are acetone, alcohols having 1 to 4 carbon atoms (such as methanol, ethanol, propanol and butanol), dimethylacetamide, ethyl acetate, butyl acetate, and tetrahydrofuran. As the first solvent (3), one type of the solvent may be used, or a plurality of types of the solvent may be used in combination.

The amount of the first solvent employed is not particularly limited, as long as the platinum elution-preventing material (4) and/or the polymerizable spacer precursor (2) can be dissolved.

Next, in the step S12, the catalyst powders (5), the platinum elution-preventing material (4), and the second solvent (6) are mixed to prepare a first liquid (7). In this procedure, the mixing method is not particularly limited. The platinum elution-preventing material (4) in the state of having a low molecular weight (unpolymerized) is uniformly and thoroughly arranged in fine pores of the catalyst powders (5).

The second solvent (6) is used for securing the dispersibility of the first liquid (7), and adjusting the viscosity. The second solvent (6) is preferably a polar solvent such that it can dissolve and disperse the platinum elution-preventing material (4) and the catalyst powders (5). As the second solvent (6), the same solvent as the first solvent (3) may be used.

The catalyst powders (5) are powders which are used in electrodes of fuel cells, particularly polymer electrolyte fuel cells, and which are composed of metal catalyst particles provided on the surface of an electric conductive carrier. In particular, the catalyst powders (5) refer to those that catalyze a reaction on a cathode electrode, and this reaction generates water from protons, oxygen, and electrons. Specific examples of the catalyst powder (5) are platinum nanoparticles. The mean particle diameter of the platinum nanoparticles is generally about 1 to 5 nm, and the specific surface area thereof is about 50 to 200 m²/g. In light of performances required for fuel cells, the particle size of platinum nanoparticles used in fuel cells is not greater than 2 to 3 nm. However, platinum having such a particle size is readily eluted under protonic acidic conditions, leading to extremely inferior catalyst stability.

The electric conductive carrier refers to a porous carrier supporting catalyst particles. Since porous carriers play a role in conducting electrons to catalyst particles, they must have electric conductivity. Specific examples of the electric conductive carrier are porous carbon particles. Porous carbon particles have fine pores having a diameter of several nm at a minimum size. The mean particle diameter of the porous carbon particles is greater than the mean particle diameter of the catalyst particles, and is usually about 20 to 100 nm, with the specific surface area being about 100 to 1,000 m²/g.

The porous carbon particles generally used may be an organic polymer electrolyte in order to form a planer electrode and to allow for binding to the surface of a gas diffusion layer such as a polymer electrolyte membrane, a carbon paper, or a carbon cloth.

For the mixing method for preparing the first liquid, a well-known method may be employed in which a planetary ball mill, a beads mill or homogenizer is used, but the mixing method is not limited thereto. The first solvent or the second solvent is preferably prevented from oxidization by binding to dissolved oxygen due to the action of the catalyst powders. Thus, the preparation of the first liquid is preferably carried out in an inert gas.

As the platinum elution-preventing material (4), only the polymerizable electrolyte precursor (1) may be used. However, the polymerizable electrolyte precursor (1) and the polymerizable spacer precursor (2) are preferably used in combination in order to control the amount of sulfonic acid groups in the resultant polymer.

Since the polymerizable spacer precursor (2) has copolymerizability with the polymerizable electrolyte precursor (1), copolymerization with the polymerizable electrolyte precursor (1) leads to incorporation of the polymerizable spacer precursor (2) into the obtained copolymer (i.e., platinum elution-preventing material (4)). The polymerizable spacer precursor (2) is a polymerizable compound not having a sulfonic acid group that is a protonic acidic functional group, but having a polycondensational functional group. Specifically, the polymerizable spacer precursor (2) is a compound represented by the formula 2: (R³O)ₘSiR⁴ₙ (wherein, R³ represents a hydrogen atom or an alkyl group having 1 to 4 carbon atoms, and R⁴ represents an alkyl group having 1 to 10 carbon atoms; m represents 2, 3 or 4, and n represents 0, 1 or 2; however, the sum of m and n is 4). R³ present in the number of 2 to 4 in the formula 2 may be the same or different. When R⁴ is present in the number of 2 in the formula 2, the two R⁴ may be the same or different. In the polymerizable spacer precursor (2), only one type of the compound may be used, or a plurality of types of the compound may be used in combination.

Similarly to R¹, examples of the alkyl group having 1 to 4 carbon atoms represented by R³ area methyl group, an ethyl group, an n-propyl group, an isopropyl group, an n-butyl group, and a t-butyl group. R³ is preferably a methyl group in light of high reactivity and ease in removal after polymerization.

R⁴ is an alkyl group having 1 to 10 carbon atoms, and the alkyl group may be linear or branched. R⁴ is selected in light of the structure of the polymerizable electrolyte precursor (1), or the amount of the polymerizable spacer precursor (2) employed. R⁴ is not particularly limited, as long as the resulting platinum elution-preventing material (4) does not inhibit the catalytic reaction, and has a sulfonic acid group in an amount capable of preventing elution of platinum.

When the polymerizable electrolyte precursor (1) and the polymerizable spacer precursor (2) are copolymerized, the mixing ratio of the polymerizable electrolyte precursor (1) to the polymerizable spacer precursor (2) may be determined appropriately, in light of an EW value and electric power generation characteristics of a platinum elution-preventing layer (8) obtained as a result of the copolymerization, a platinum elution-preventing layer (8) being described later. The mixing ratio of the polymerizable electrolyte precursor (1) to the polymerizable spacer precursor (2) falls within the range of preferably 1:0.25 to 10, and more preferably 1:0.5 to 8 in terms of the molar ratio.

EW is an abbreviation of “Equivalent Weight”, and represents the weight of a dry electrolyte membrane per mol of sulfonic acid groups. As the EW value is smaller, the proportion of the sulfonic acid groups included in its electrolyte is greater. It is not preferred that the platinum elution-preventing layer (8) formed according to the present invention has too great EW value for securing both the stability of the platinum catalyst, and the electric power generation characteristic of the cathode electrode. Since the polymer electrolyte layer of the cathode electrode for fuel cells according to the present invention has an EW value of not greater than 1,500, it is preferred to adjust the mixing ratio of the polymerizable electrolyte precursor (1) to the polymerizable spacer precursor (2) such that the EW value becomes not greater than 1,500.

According to the present embodiment, description has been made in connection with a case in which the polymerizable spacer precursor (2) is used; however, the polymerizable spacer precursor (2) may not be used as described above since it is an optional component. Even if the polymerizable spacer precursor (2) is not used, the platinum elution-preventing layer (8) having the sulfonic acid groups in a controlled amount can be formed by controlling the structure (for example, the number of carbon atoms of the alkylene group R²) of the lipophilic moiety included in the platinum elution-preventing material (4).

During operation of the fuel cell, water is continuously produced at the catalytic site of the cathode electrode by an oxygen reduction reaction. Therefore, it is necessary that the platinum elution-preventing layer has water repellency so as to enable efficient drainage. The water repellency of the platinum elution-preventing layer is controlled by the structure of the polymerizable electrolyte precursor (1) and the polymerizable spacer precursor (2) which constitute the platinum elution-preventing material (4), or the mixing ratio of the polymerizable electrolyte precursor (1) to the polymerizable spacer precursor (2).

In the step S13 and step S14, by subjecting the first liquid (7) to a vacuum treatment or a heat drying treatment, the platinum elution-preventing material (4) contained in the first liquid (7) is converted into the platinum elution-preventing layer (8) due to the polycondensation of the platinum elution-preventing material (4). The platinum nanoparticles, namely, the catalyst particles, are covered with the platinum elution-preventing layer (8) so as to form a preventing layer-covered catalyst.

In the step S15, the preventing layer-covered catalyst (9), a polymer electrolyte (10), and a third solvent (11) are mixed to produce a second liquid (12). As the polymer electrolyte (10), a perfluoro-alkylsulfonic acid based polymer which is often used in catalyst electrodes for fuel cells in general, may be used, and the polymer electrolyte (10) is not particularly limited as long as it is an electrolyte material having a comparative level of the proton conductivity. As the third solvent (11), the solvent that is the same as the first solvent (3) or the second solvent (6) may be used. For the third solvent (11), one type of the solvent may be used, or a plurality of types of the solvent may be used in combination.

Finally, in the step S16, the second liquid (12) obtained in the step S15 is applied on a polymer electrolyte film that is to be a substrate, which is further subjected to a dry treatment to remove the solvent. Accordingly, a cathode electrode for fuel cells (13) having the preventing layer-covered catalyst (9) and the polymer electrolyte (10) is formed. For example, the second liquid (12) is applied directly on an electrolyte membrane constituted with a perfluorosulfonic acid based polymer such as Nafion (registered trademark, manufactured by DuPont). Then, the second liquid (12) is dried to allow the preventing layer-covered catalyst (9) to be adhered on the electrolyte membrane surface. Thus, the cathode electrode for fuel cells (13) is formed.

The cathode electrode for fuel cells (13) manufactured via the steps S11 to S16 has a structure in which platinum nanoparticles that are the catalyst powders (5) are covered by the platinum elution-preventing layer (8), and in which further the polymer electrolyte (10) is arranged on the external side of the platinum elution-preventing layer (8). This structure allows a sufficient amount of protons produced on the anode electrode to be supplied to most of the catalyst surface present on the cathode electrode. As a result, deterioration of the platinum nanocatalyst (catalyst metal) associated with elution under acidic conditions can be prevented while high electric power generation characteristics are achieved.

The cathode electrode for fuel cells manufactured according to the present invention is provided opposite to an anode electrode via a polymer electrolyte membrane such as a perfluorosulfonic acid based electrolyte membrane, and then a separator is provided on the external sides of the cathode electrode and the anode electrode so as to sandwich the entirety. Accordingly, construction of a fuel cell is completed.

### Examples

Hereinafter, the present invention is explained in more detail by way of Examples, but the present invention is not limited to these Examples.

### 1. Solubility of Platinum Elution-Suppressing Layer in Solvent

According to the method described above, a polymerizable electrolyte precursor having a sulfonic acid group and a (R¹O)₃Si-group was first diluted in an organic solvent. Thereafter, a low molecular weight material insoluble in water was added as a polymerizable spacer precursor and mixed therewith to prepare a platinum elution-preventing material. With the solution containing the platinum elution-preventing material were mixed catalyst powders and an organic solvent, and the mixture was subjected to a drying treatment under reduced pressure to remove the solvent. The platinum elution-preventing material copolymerized, and thus a platinum elution-preventing layer was obtained on the surface of the catalyst powders.

Specific experiment procedure was as in the following. A trihydroxyalkylsilane compound having a sulfonic acid group ((HO)₃Si—(CH₂)₃—SO₃H, 30% by weight aqueous solution, manufactured by Gelest, Inc.) in an amount of 10 mmol was used as a polymerizable electrolyte precursor. This compound was diluted with t-BuOH to prepare a 10% by weight solution. Thereafter, 10 mmol of (MeO)₃Si—Me was added as a polymerizable spacer precursor, and the mixture was stirred for 15 min. Furthermore, t-BuOH was added and mixed therewith to prepare a platinum elution-preventing material as a colorless transparent solution. In this way, a uniform solution having a molar ratio of the polymerizable electrolyte precursor having a sulfonic acid group to the polymerizable spacer precursor not having a sulfonic acid group of 1:1 was obtained. This solution had an EW value of 280.

Next, the solvent of the aforementioned 10% by weight solution was gradually removed under a reduced pressure to allow the polymerize reaction to proceed. As a result, a polysiloxane solid (corresponding to the platinum elution-preventing layer) that was insoluble in water was obtained. The polysiloxane solid has a siloxane (Si—O—Si) skeleton.

In order to confirm the insolubility in water of the polysiloxane solid obtained as a membranous substance, the polysiloxane solid was immersed in water, and the mixture was stirred overnight. When the supernatant liquid was collected and its moisture was eliminated under a reduced pressure, any precipitation of the polysiloxane compound was not confirmed. When solid NMR measurement was carried out on the polysiloxane solid, chemical shift values of signal peaks determined on ¹³C-DDMAS-NMR (single pulse and 1H decoupled) and ²⁹Si-CPMAS-NMR (1H→13C cross polarization and 1H decoupled) well agreed with theoretical values expected from its molecular structure. Accordingly, it was ascertained that the polysiloxane solid was a copolymerized product having an intended molecular structure.

The present invention enabled platinum elution-preventing materials to be prepared in which (HO)₃Si—(CH₂)₃—SO₃H and (MeO)₃Si—Me were mixed at a molar ratio of 1:n (n=0, 0.5, 1, 2, 3, 4, or 5). After each platinum elution-preventing material was transferred to an eggplant flask, the solvent was eliminated using a diaphragm pump under a reduced pressure to obtain an aggregated polysiloxane solid (corresponding to the platinum elution-preventing layer) via a polymerize reaction. The polysiloxane solid in which n is 1, 2, 3, 4, or 5 was confirmed to be insoluble in water.

In order to examine the solubility of the polysiloxane solid in which n is 1, 2, or 3 in an organic solvent, these polysiloxane solids were immersed in acetone or ethyl alcohol, and the mixture was stirred overnight. However, it was ascertained that these polysiloxane solids were not dissolved in acetone or ethyl alcohol at all.

A polymerizable electrolyte precursor (HO)₃Si—(CH₂)₃—SO₃H and a polymerizable spacer precursor (MeO)₃Si—C₆H₁₃ which had a C6 alkyl chain (manufactured by Tokyo Chemical Industry Co., Ltd.) were mixed at a molar ratio of 1:n (n=0.50, 0.75, 1, 2, 3, 6, or 10) to prepare a platinum elution-preventing material. A polysiloxane solid (corresponding to platinum elution-preventing layer) was obtained by drying each solution containing the platinum elution-preventing material to allow for a polymerization reaction of the platinum elution-preventing material. Thus resultant polysiloxane solids were immersed in acetone or ethyl alcohol, and stirred overnight. However, it was ascertained that these polysiloxane solids were not in any how dissolved in acetone or ethyl alcohol.

A polymerizable electrolyte precursor (HO)₃Si—(CH₂)₃—SO₃H and a polymerizable spacer precursor (MeO)₃Si—C₁₀H₂₁ which had a C10 alkyl chain (manufactured by Shin-Etsu Chemical Co., Ltd.) were mixed at a molar ratio of 1:n (n=0.50, 0.75, 1, 2, 3, 4, 6, or 8) to prepare a platinum elution-preventing material. Each solution containing the platinum elution-preventing material was dried to allow for a polymerization reaction of the platinum elution-preventing material, to obtain a polysiloxane solid (corresponding to a platinum elution-preventing layer). Thus resultant polysiloxane solids were immersed in acetone or ethyl alcohol, and stirred overnight. However, it was ascertained that these polysiloxane solids were not dissolved in acetone or ethyl alcohol at all.

Examples of the solvent which may be used for preparing the above-mentioned platinum elution-preventing materials are in addition to t-BuOH, lower alcohols such as acetone and ethanol, and dimethylacetamide.

### 2. Manufacture of Electrodes for Fuel Cells A to G

A method for producing a cathode electrode for fuel cells using the platinum elution-preventing materials obtained according to the method described in the above section 1. Solubility of Platinum Elution-Suppressing Layer in Solvent is explained below.

Seven types of platinum elution-preventing materials were first prepared with combinations and composition ratios of the compounds shown in Table 1. These 7 types of platinum elution-preventing materials contained (HO)₃Si—(CH₂)₃—SO₃H as a polymerizable electrolyte precursor, and (MeO)₃Si—R (wherein R is an alkyl group and Me is a methyl group) as a polymerizable spacer precursor, each at a specified molar ratio. To 1 g of the mixture of 2 types of monomers that accounts for the solid matter were added as the first solvent 5 g of ultra-pure water and 6.5 g of t-BuOH to prepare the first liquid adjusted to have a concentration of 8% by weight.

In connection with the mixing ratio of the polymerizable electrolyte precursor to the polymerizable spacer precursor shown in Table 1, appropriate molar compositions having electric current-voltage characteristics suited for cathode electrodes were selected among the water insoluble materials produced in the above section 1. Solubility of Platinum Elution-Suppressing Layer in Solvent. The polymerizable electrolyte precursor and the polymerizable spacer precursor contained in these platinum elution-preventing materials were solvated in a low molecular state.

Subsequently, platinum-supporting carbon (TEC10E50E) manufactured by Tanaka Kikinzoku Kogyo K.K. as the catalyst powders, each 11 types of the platinum elution-preventing material, and t-BuOH as the second solvent were mixed to prepare the first liquids. In this regard, production of the electrode A is first explained. Into a polypropylene beaker was first weighed 5 g of carbon having a catalyst powder made of platinum, and 5 g of t-BuOH was added thereto. The mixture was stirred such that t-BuOH was entirely blended. Next, 10 g of the platinum elution-preventing material (8% by weight solution) was added thereto, and further 15 g of t-BuOH and 5 g of pure water were added. Thereafter, the mixture was treated with an ultrasonic homogenizer to prepare the first liquid. In the first liquids prepared in manufacturing the electrode A, the weight ratio of the platinum elution-preventing material to the catalyst powder was adjusted to about 20%. The catalyst powders used in this procedure had a porous structure in which platinum nanoparticles having a mean particle diameter of about 2 to 3 nm were supported on the surface of carbon fine powders (carbon black).

The first liquids for manufacturing the electrode B to electrode G were prepared in a similar manner to that of the electrode A such that the weight constituent ratio became 5 to 40%. The weight constituent ratio was optimized in view of electric power generation characteristics of finally manufactured each electrode.

Most of the solvent of the first liquid was eliminated by stirring under a reduced pressure at room temperature. The platinum elution-preventing material turned into a platinum elution-preventing layer as the polycondensation reaction proceeds. Moreover, by carrying out a vacuum treatment at 1 Torr and at 80° C. for 2 hrs, a preventing layer-covered catalyst in which a platinum elution-preventing layer was provided in the vicinity of platinum particles was synthesized. The solvent contained in the first liquid may be eliminated also with a spray dry method or freeze dry method. The method for eliminating the solvent may be selected depending on the material shape of the desired catalyst.

Next, the preventing layer-covered catalyst, the electrolyte, and the third solvent were kneaded to prepare the second liquid. Specifically, 6 g of a dispersion liquid of Nafion (registered trademark) (10% by weight, manufactured by Aldrich Co.,) as the perfluorocarbon sulfonic acid polymer electrolyte was added to 1.15 g of the preventing layer-covered catalyst, and thereto were further added water and alcohol for adjusting the viscosity, followed by stirring the mixture to prepare a catalyst electrode liquid for cathode electrode A.

On the other hand, liquid for an anode electrode was prepared according to the following process. After 2 g of platinum-supporting carbon (TEC10E50E, manufactured by Tanaka Kikinzoku Kogyo K.K.) was dispersed in 10 g of a dispersion liquid of Nafion (registered trademark) (10% by weight, manufactured by Aldrich Co.,), thereto were further added water and ethanol to adjust the viscosity. Accordingly, the second liquid was prepared.

The weight of the polymer electrolyte added to the preventing layer-covered catalyst and the catalyst powders was determined in light of the requirements for the material employed to be the second liquid, and the electric power generation characteristics as the catalyst electrode. The weight of the polymer electrolyte added to the preventing layer-covered catalyst and the catalyst powder is not limited to weight demonstrated in Examples.

Subsequently, the catalyst electrode liquid for cathode electrode A was applied on a polymer electrolyte membrane, Nafion (registered trademark) NR-211 (manufactured by Du Pont Kabushiki Kaisha) to produce a cathode electrode A that was a membrane-electrode assembly (MEA). The catalyst electrode paste for an anode electrode was applied on a polymer electrolyte membrane Nafion (registered trademark) NR-211 (manufactured by Du Pont Kabushiki Kaisha) to produce an anode electrode that was a membrane-electrode assembly (MEA). Thereafter, a single cell for fuel cells was constructed with the cathode electrode A and the anode electrode.

The second liquid was die coated on the substrate such that the amount of platinum supported by the cathode electrode became 0.3 mg/cm². The catalyst electrode paste was die coated on the substrate such that the amount of platinum supported by the anode electrode became 0.2 mg/cm².

In the above Examples, the cathode electrode and the anode electrode were produced by die coating of the catalyst electrode paste on the polymer electrolyte membrane in accordance with a method for producing MEA for general fuel cells; however, the method for producing the cathode electrode is not limited thereto.

In a similar manner to the case of the cathode electrode A, the polymerizable electrolyte precursor and the polymerizable spacer precursor shown in Table 1 were mixed at each molar ratio shown in Table 1 to prepare the second liquid, and then cathode electrodes B to G were produced. A single cell for fuel cells was constructed with each of the cathode electrodes B to G and the anode electrode, similarly to the cathode electrode A.

### Comparative Example 1

### Manufacture of Comparative Electrode

A comparative electrode was produced using a perfluorocarbon sulfonic acid electrolyte having an EW value of 1,000. Specifically, after 2 g of platinum-supporting carbon (TEC10E50E, manufactured by Tanaka Kikinzoku Kogyo K.K.) was dispersed in 10 g of a dispersion liquid of Nafion (registered trademark) (10% by weight, manufactured by Aldrich Co.,), water and ethanol were further added thereto to adjust the viscosity. Accordingly, a paste was produced. A cathode electrode that was MEA was produced using a polymer electrolyte membrane Nafion (registered trademark) NR-211 (manufactured by Du Pont Kabushiki Kaisha) and the paste. A single cell for fuel cells was constructed with the cathode electrode, and the above-mentioned anode electrode.

The paste was die coated on the substrate such that the amount of platinum supported on the comparative electrode became 0.3 mg/cm².

### 3. Change in Catalytic Reaction Area (ECA) of Electrode for Fuel Cells

A catalyst deterioration test was performed on the single cells for fuel cells having each of the electrodes A to G, and the comparative electrode as a cathode electrode, while supplying hydrogen gas (65° C., 100% RH) to the anode electrode, and supplying nitrogen gas (65° C., 100% RH) to the cathode electrode.

Protocol of the catalyst deterioration test was as follows. The cathode electrode was subjected to potential load change of 5,000 cycles in total, with one cycle executed for 6 seconds: at 0.6 V for 3 sec, and at 1.0 V for 3 sec. Then, the electrochemical surface area (ECA) of platinum was measured on the cathode electrodes before and after the test, by a cyclic voltammetry method to calculate the rate of ECA retention after testing. Table 1 shows the ECA after the catalyst deterioration test, in terms of the relative value with the initial value assumed to be 100%, on each electrode.

TABLE 1

| | | | | | EGA after |
|---|---|---|---|---|---|
| | Platinum elution-preventing | | Molar | | catalyst |
| | material (3) | | ratio | | deterioration |
| | Polymerizable | Polymerizable | of | | test (initial |
| Electrode | electrolyte | spacer precursor | mixing | EW | value assumed |
| number | precursor (1) | (2) | (1):(2) | value | to be 100%) |
| Electrode A | (HO)₃Si(CH₂)₃SO₃H | (MeO)₃SiCH₃ | 1:1 | 280 | 63 |
| Electrode B | (HO)₃Si(CH₂)₃SO₃H | (MeO)₃SiCH₃ | 1:3 | 380 | 69 |
| Electrode C | (HO)₃Si(CH₂)₃SO₃H | (MeO)₃Si(CH₂)₅CH₃ | 1:3 | 640 | 71 |
| Electrode D | (HO)₃Si(CH₂)₃SO₃H | (MeO)₃Si(CH₂)₅CH₃ | 1:4 | 780 | 78 |
| Electrode E | (HO)₃Si(CH₂)₃SO₃H | (MeO)₃Si(CH₂)₅CH₃ | 1:6 | 1,070 | 82 |
| Electrode F | (HO)₃Si(CH₂)₃SO₃H | (MeO)₃Si(CH₂)₉CH₃ | 1:1 | 400 | 67 |
| Electrode G | (HO)₃Si(CH₂)₃SO₃H | (MeO)₃Si(CH₂)₉CH₃ | 1:2 | 600 | 72 |

| | | | |
|---|---|---|---|
| Comparative | Perfluorosulfonic acid based polymer | 1,000 | 54 |
| Electrode | electrolyte | | |

As shown in Table 1, ECA decreased to half the initial value in the comparative electrode in which only a perfluorosulfonic acid based polymer electrolyte was used. To the contrary, the electrodes A to G produced by providing the platinum elution-preventing layer beforehand, and then mixing with the polymer electrolyte exhibited a high rate of ECA retention of from 70% to 90%. The electric current-voltage characteristics of the cathode electrodes A to G provided with the platinum elution-preventing layer were comparative or superior to those of the cathode electrode without having a platinum elution-preventing layer.

According to the cathode electrodes for fuel cells thus produced in Examples, it was revealed that initial characteristics of the fuel cells can be improved, whereas stability was also successfully secured for a long period of time.

### INDUSTRIAL APPLICABILITY

The cathode electrode manufactured by the manufacturing method of a cathode electrode for fuel cells of the present invention can maintain electric power generation characteristics of fuel cells owing to a catalyst deterioration-preventive effect for a long period of time. The manufacturing method of a cathode electrode for fuel cells of the present invention is also advantageous in reducing the amount of noble metal electrode particles and catalyst particles finely dispersed in porous structures, and securing the reliability, and thus can be helpful in manufacturing a stable and inexpensive cathode electrode for fuel cells. Thus, the present cathode electrode for fuel cells and the present manufacturing method thereof, as well as fuel cells provided with the present cathode electrode for fuel cells are useful in the technical field of fuel cells.

PTL 3 discloses on the front page as in the following.

A method for manufacturing an electrode is provided which enables a three-phase interface where a reactant gas, a catalyst and an electrolyte are associated to be sufficiently secured in carbon, and which improves utilization efficiency of a catalyst.

A manufacturing method of a fuel cell electrode, the method including the steps of: allowing a carbon carrier having fine pores to support a catalyst; introducing into the surface and/or the fine pores of the carbon carrier a functional group to be a polymerization initiator; introducing an electrolyte monomer or an electrolyte monomer precursor to permit polymerization of the electrolyte monomer or the electrolyte monomer precursor with the polymerization initiator as a starting point; protonating the polymer of the catalyst-supporting carrier, drying, dispersing in water and filtrating the product to obtain catalyst powders; and forming a catalyst paste using thus obtained catalyst powders to produce a catalyst layer, the manufacturing method of a fuel cell electrode being characterized by mixing the catalyst paste with a perfluorocarbon polymer having a sulfonic acid group when the catalyst layer is produced.

PTL 5 in Example 12 discloses as in the following.

### Example 12

Platinum catalyst-supporting carbon black (TEC10A30E; manufactured by Tanaka Kikinzoku Kogyo K.K.) in an amount of 5.0 g, 5.0 g of tetraethoxysilane, and 4.0 g of a 33% aqueous solution of 3-(trihydroxysilyl)-1-propane sulfonic acid were homogenously dispersed in 15 g of isopropyl alcohol using a homogenizer. This liquid was applied on two faces of a proton conductive membrane using a roll coater so as to give a thickness of 30 μm. To the membrane on which the liquid was applied was pasted a carbon paper TGP-H-120 (manufactured by Toray Industries, Inc.,), and pressed with a pressing machine under a pressure of 5.0 N/cm² for 2 hrs, followed by placing in a constant temperature and humidity chamber at 80° C. and 95% RH for 12 hrs to obtain a membrane-electrode assembly.

A cell for evaluation was produced in a similar manner to Example 1, and an evaluation was made. According to the results, the maximum output of 35 (mW/cm²), the critical current density of 0.23 (A/cm²), and the state of adhesion being favorable were indicated.

1. A manufacturing method of a cathode electrode for fuel cells,
the method comprising steps of:
mixing a polymerizable electrolyte precursor having a sulfonic acid group and a group represented by (R¹O)₃Si— (wherein, R¹ represents a hydrogen atom or an alkyl group having 1 to 4 carbon atoms) in the molecule thereof, with a first solvent to prepare a platinum elution-preventing material;
preparing a first liquid by mixing catalyst powders having catalyst particles on at least the surface thereof, the platinum elution-preventing material and a second solvent;
polymerizing the platinum elution-preventing material in the first liquid by carrying out a drying treatment under reduced pressure or a heat drying treatment to form a platinum elution-preventing layer containing the polymer of the platinum elution-preventing material on the catalyst powder surfaces to obtain a preventing layer-covered catalyst;
mixing the preventing layer-covered catalyst, a third solvent, and a polymer electrolyte to prepare a second liquid; and
applying the second liquid on a substrate, and removing the third solvent to obtain the cathode electrode.

2. The manufacturing method of a cathode electrode for fuel cells according to claim 1, wherein the polymerizable electrolyte precursor is a compound represented by the formula: (R¹O)₃Si—R²—SO₃H (wherein, R¹ represents a hydrogen atom or an alkyl group having 1 to 4 carbon atoms, and R² represents an alkylene group having 1 to 15 carbon atoms).

3. The manufacturing method of a cathode electrode for fuel cells according to claim 1, wherein the first solvent is at least one selected from the group consisting of acetone, an alcohol having 1 to 4 carbon atoms, dimethylacetamide, ethyl acetate, butyl acetate, and tetrahydrofuran.

4. The manufacturing method of a cathode electrode for fuel cells according to claim 1, wherein the polymer electrolyte is a perfluorocarbon sulfonic acid resin.

5. The manufacturing method of a cathode electrode for fuel cells according to claim 1, wherein the platinum elution-preventing material further comprises a polymerizable spacer precursor not having a protonic acidic functional group but having a polycondensational functional group, and
the polymerization product of the platinum elution-preventing material comprises a copolymer of the polymerizable electrolyte precursor and the polymerizable spacer precursor.

6. The manufacturing method of a cathode electrode for fuel cells according to claim 5, wherein the polymerizable spacer precursor is a compound represented by (R³O)ₘSiR⁴ₙ (wherein, R³ represents a hydrogen atom or an alkyl group having 1 to 4 carbon atoms, and R⁴ represents an alkyl group having 1 to 10 carbon atoms; m represents 2, 3 or 4, and n represents 0, 1 or 2; however, the sum of m and n is 4).

7. A cathode electrode for fuel cells comprising catalyst powders having catalyst particles on at least the surface thereof, a platinum elution-preventing layer on the catalyst powder surfaces, and further a polymer electrolyte on the external side thereof, wherein
the platinum elution-preventing layer comprises a copolymer of a polymerizable electrolyte precursor represented by (R¹O)₃Si—R²—SO₃H (wherein, R¹ represents a hydrogen atom or an alkyl group having 1 to 4 carbon atoms, and R² represents an alkylene group having 1 to 15 carbon atoms), with a polymerizable spacer precursor represented by (R₃O)ₘSiR⁴ₙ (wherein, R³ represents a hydrogen atom or an alkyl group having 1 to 4 carbon atoms, and R⁴ represents an alkyl group having 1 to 10 carbon atoms; m represents 2, 3 or 4, and n represents 0, 1 or 2; however, the sum of m and n is 4).
